(19) United States
(12) Patent Application Publication
(10) Pub. No.: US 2009/0312495 A1
(43) Pub. Date: Dec. 17, 2009

(54) Molding Material For Welding

(75) Inventors: Masaki Maeda, Tokyo (JP); Gou Yamada, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TECHNO POLYMER CO., LTD., Chuo-ku, Tokyo (JP)

(21) Appl. No.: 12/158,818

(22) PCT Filed: Dec. 20, 2006
(86) PCT No.: PCT/JP2006/325420

§ 371 Date: Jun. 23, 2008

(30) Foreign Application Priority Data
Dec. 27, 2005 (JP) 2005-376196
Dec. 27, 2005 (JP) 2005-376197

(51) Int. Cl. C08L 33/02

(52) U.S. Cl. 525/221

(57) ABSTRACT

The objective of the present invention is to provide a molding material for welding, which is capable of inhibiting occurrences of a string-shaped burr, a stringing between a heated mold such as a heated plate, and the constituting material of a housing, and the like, and of improving a failure of the appearance when a welding method such as vibration welding and hot plate welding is applied for joining resin parts. The present molding material comprises a rubber-reinforced resin obtained by polymerizing a vinyl-based monomer containing an aromatic vinyl compound and a cyanidated vinyl compound in the presence of an acryl-based rubbery polymer whose toluene gel content is less than 70%, or a mixture consisting of the rubber-reinforced resin and a (co)polymer of a vinyl-based monomer, and has the acryl-based rubbery polymer in an amount from 5 to 40% by mass with respect to the total amount of the molding material.

### TECHNICAL FIELD

The present invention relates to a molding material for welding. More particularly, the present invention relates to a molding material for welding which is suitable in welding of parts consisting of this molding material with one another, and in welding of a part consisting of this molding material and a part consisting of other molding material.

### BACKGROUND ART

Conventionally, a housing and a container (including a hollow product such as fuel tank) used in wide fields exemplifying daily goods, parts for vehicles, electric/electronic parts, mechanical parts and the like are manufactured by welding two molded articles which have been previously prepared by splitting into two parts at the respective peripheral portions by a method such as vibration welding, hot plate welding, laser welding and the like to integrate. In addition, a meter (measuring device) for vehicles and for measuring apparatuses is manufactured by integrating a meter case having a measuring apparatus therein and a covering body made of a transparent resin with the above-mentioned welding method and the like. Further, a hose connector, a cut-off valve, a fuel pump casing, an inlet pipe and the like for a variety of vehicles are also manufactured by forming resin parts consisting of a thermoplastic molding material and integrating applying vibration welding, hot plate welding, laser welding and the like, depending on purposes such as for inhibiting a leakage (for example in JP-A 2004-67841, JP-A 2005-219219).

Additionally, it is known that the peripheral portion of a lamp-housing and the peripheral portion of a lens made of a resin are joined by means of the above-mentioned method regarding the lamp-housing for vehicles (for example in JP-A H11-199727, JP-A 2005-182835).

A molding material sometimes leads to occurrences of a resin powder, a (string-shaped) burr, a downed burr and the like around the welding portion in the case of the vibration welding method. Further, in the case of the hot plate welding method, a stringing and the like may be occurred at the time when the portion that is to be joined and is in the state where the molding material is melted leaves from a heated mold. These failure phenomena may deteriorate the appearance as an end-product.

Moreover, a lamp-housing for two-wheelers, four-wheelers, appliances and the like is manufactured using a thermoplastic resin composition disclosed, for example, in JP-A H11-199727, JP-A 2005-182835 and the like. For example, when a lamp for vehicles is manufactured by using a lamp-housing, the peripheral portion of the lamp-housing and the peripheral portion of a lens made of a resin are joined by a method such as vibration welding, hot plate welding, laser welding and the like.

In the case the vibration welding method is applied, a resin powder, a (string-shaped) burr, a downed burr and the like sometimes occur around the joined portion. And in the case the hot plate welding method is applied, a stringing sometimes occurs when the portion that is to be joined and is in the state where the constituting material (resin component) of the lamp-housing is melted leaves from a heated mold. These failure phenomena may deteriorate the appearance as a lamp.

Furthermore, for the purpose of enhancing the luminance of the lamp which has emitted, a surface for reflecting light is usually formed by means of a surface treatment such as providing a metal layer on an inner surface of the lamp-housing. When the surface treatment is performed, a coating treatment for reflecting, a vapor deposition treatment and the like may be applied, however, an undercoatless-metalizing capable of reducing VOC is mainly performed considering environmental problems nowadays. In such a case of providing no undercoats, there is a problem such that fine concaves and convexes existing on the surface of the molded article lead to a lowered luminance. Thus, an excellent luminance cannot be obtained unless an undercoat is provided.

Since it is considered that the above-mentioned failure phenomena largely depend upon the resin component, a molecular designing of the resin component, a manufacturing method and the like have been studied. For example, JP-A 2005-182835 discloses a thermoplastic resin composition containing a rubber-reinforced resin obtained by using a rubbery polymer having a gel content of 70% or more, a maleimide-based copolymer and the like.

### DISCLOSURE OF THE INVENTION

### [Problems to be Solved by the Invention]

The objective of the present invention is to provide a molding material for welding, which is capable of inhibiting occurrences of a resin powder, a (string-shaped) burr and the like around the welding portion in the case the vibration welding method is applied, of inhibiting occurrences of a stringing and the like between a heated mold such as heated plate, and the present molding material in the case the hot plate welding and of improving a failure of the appearance, when joining of parts consisting of this molding material with one another, or of a part consisting of this molding material and a part consisting of other molding material is performed.

Additionally, the objective of the present invention is to provide a molding material for forming a lamp-housing, which is capable of inhibiting occurrences of a resin powder, a (string-shaped) burr and the like around the joined portion in the case the vibration welding method is applied, of inhibiting occurrences of a stringing and the like between a heated mold such as heated plate, and the constituting material of the lamp-housing in the case the hot plate welding and of being excellent in luminance, when a lamp-housing for vehicles, appliances and the like, and other part (such as a lens made of a resin) are joined.

### [Means for Solving Problems]

The present invention is as follows.
1. A molding material for welding, comprising an acrylic rubber-reinforced vinyl-based resin [A1] obtained by polymerizing a vinyl based monomer [b1] containing an aromatic vinyl compound and a cyanidated vinyl compound in the presence of an acryl-based rubbery polymer [a1] whose toluene gel content is less than 70%, or a mixture consisting of the acrylic rubber-reinforced vinyl-based resin [A1] and a (co)polymer [A2] of a vinyl based monomer [b2], wherein content of the acryl-based rubbery polymer [a1] is in the range from 5 to 40% by mass with respect to the total amount of the molding material for welding.
2. The molding material for welding according to above 1, wherein the acryl-based rubbery polymer [a1] is a copolymer of an acrylic acid alkyl ester (m1) having an alkyl group whose carbon number is in the range from 1 to 12, a compound (m2) which is copolymerizable with the acrylic acid alkyl ester (m1) and a multifunctional vinyl compound (m3), and has a mean volume particle diameter in the range from 40 to 190 nm, and has a degree of swelling in toluene is in the range from 6 to 20, wherein the ratio of the acrylic acid alkyl ester (m1) and the compound (m2) to be used based on 100% by mass of the total amount of these compounds are 60 to 100% by mass and 0 to 40% by mass, respectively, and wherein the amount of the multifunctional compound (m3) to be used based on 100 parts by mass of the total amount of the acrylic acid alkyl ester (m1) and the compound (m2) is in the range from 0.1 to 10 parts by mass.
3. The molding material for welding according to above 1, wherein the acryl-based rubbery polymer [a1] is a polymer that is obtained by comprising first step for copolymerizing an acrylic acid alkyl ester (m11) having an alkyl group whose carbon number is in the range from 1 to 12, a compound (m21) which is copolymerizable with the acrylic acid alkyl ester (m11) and a multifunctional vinyl compound (m31) at a polymerization conversion rate of 85% or higher, and second step for copolymerizing an acrylic acid alkyl ester (m12) having an alkyl group whose carbon number is in the range from 1 to 12, a compound (m22) which is copolymerizable with the acrylic acid alkyl ester (m12) and a multifunctional vinyl compound (m32) in the presence of the copolymer obtained by the first step at a polymerization conversion rate of 85% or higher, wherein the total amount of the acrylic acid alkyl ester (m11) and the compound (m21) to be used in the first step based on 100% by mass of the total of the acrylic acid alkyl esters (m11) and (m12) and the compounds (m21) and (m22) is in the range from 50 to 90% by mass, and the amount of the multifunctional vinyl compound (m31) to be used is in the range from 0.01 to 0.3 part by mass based on 100 parts by mass of the acrylic acid alkyl esters (m11) and the compounds (m21), and wherein the total amount of the acrylic acid alkyl ester (m12) and the compound (m22) to be used in the first step based on 100% by mass of the total of the acrylic acid alkyl esters (m11) and (m12) and the compounds (m21) and (m22) is in the range from 10 to 50% by mass, and the amount of the multifunctional vinyl compound (m32) to be used is in the range from 0.5 to 10 parts by mass based on 100 parts by mass of the acrylic acid alkyl esters (m12) and the compounds (m22).
4. The molding material for welding according to above 1, wherein the toluene gel content of the acryl-based rubbery polymer [a1] is in the range from 45 to 69%.
5. The molding material for welding according to above 1, wherein the content of the acryl-based rubbery polymer [a1] is in the range from 10 to 30% by mass based on the total of the molding material for welding.
6. The molding material for welding according to above 1, wherein the number of stringing observed at the time a test piece which is made of the molding material for welding and has a length of 100 mm, a width of 30 mm and a thickness of 3 mm is released from a heated plate after the test piece is subjected to conditioning at a temperature of 23° C. and at a relative humidity of 50% for 3 hours, and to contacting with the heated plate under a test condition below is 3 pieces or less.

### <Test Conditions>

Temperature of the heated plate; 280° C.
Transfer speed; 200 mm/sec.
Time for contacting the test piece with the heated plate; 15 sec.
Melted length of the test piece; 0.5 mm
7. The molding material for welding according to above 1, wherein the deflection temperature (under load) measured in accordance with ISO75 is 80° C. or higher.
8. The molding material for welding according to above 1, wherein it is for molding a lamp-housing.

It is noted that each of the compound (m2), compound (m21) and compound (m22) is a compound which is capable of copolymerizing with an acrylic acid alkyl ester and does not include a multifunctional vinyl compound.

### [Effects of the Invention]

Since the molding material for welding of the present invention is a molding material for welding one comprising an acrylic rubber-reinforced vinyl-based resin [A1] obtained by polymerizing a vinyl based monomer [b1] containing an aromatic vinyl compound and a cyanidated vinyl compound in the presence of an acryl-based rubbery polymer [a1] whose toluene gel content is less than 70%, or a mixture consisting of the acrylic rubber-reinforced vinyl-based resin [A1] and a (co)polymer [A2] of a vinyl based monomer [b2], occurrences of a resin powder, a (string-shaped) burr and the like around the welding portion may be inhibited in the case the vibration welding method is applied, and occurrences of a stringing and the like between a heated mold such as heated plate, and the present molding material may be inhibited in the case the hot plate welding and of improving a failure of the appearance, when joining of parts consisting of this molding material with one another, or of a part consisting of this molding material and a part consisting of other molding material is performed. In addition, when a secondary operation such as sputtering method and vacuum deposition method is performed for forming a metal layer comprising aluminum, chromium or the like on the surface of a molded article, it is not necessary to apply an undercoat treatment, and the above-mentioned metal layer can lead to a surface excellent in gloss and a reflectable surface of light.

Further, according to the present invention, occurrences of a resin powder, a (string-shaped) burr and the like around the joined portion may be inhibited in the case the vibration welding method is applied, and occurrences of a stringing and the like between a heated mold such as heated plate, and the constituting material of the lamp-housing may be inhibited in the case the hot plate welding and of being excellent in luminance, when a lamp-housing for vehicles, appliances and the like, and other part (such as a lens made of a resin) are joined. Additionally, when a metal layer comprising aluminum, chromium or the like is directly formed on the surface of a molded article by sputtering method, vacuum deposition method or the like without applying an undercoat treatment, an excellent luminance of a lamp can be obtained.

The molding material for welding of the present invention is useful as a molding material suitable for vibration welding method, hot plate welding method and laser welding method, and leads to a simplification in changing of device and material used in the manufacturing step of a variety of molding articles, and the like. This is extremely valuable in industry.

### BEST MODE FOR CARRYING OUT THE INVENTION

The present invention is described in further detail.

The molding material for welding of the present invention is a molding material for welding one comprising an acrylic rubber-reinforced vinyl-based resin [A1] obtained by polymerizing a vinyl based monomer [b1] containing an aromatic vinyl compound and a cyanidated vinyl compound in the presence of an acryl-based rubbery polymer [a1] whose toluene gel content (hereinafter, referred to as “gel content”) is less than 70%, or a mixture consisting of the acrylic rubber-reinforced vinyl-based resin [A1] and a (co)polymer [A2] of a vinyl based monomer [b2], wherein content of the acryl-based rubbery polymer [a1] is in the range from 5 to 40% by mass with respect to the total amount of the molding material for welding. And the number of stringing observed at the time a test piece which is made of the molding material for welding is released from a heated plate is 3 pieces or less after the test piece is subjected to contacting with the heated plate under a specified condition. In this specification, “(co)polymer(ize)” means homopolymer(ize) and copolymer(ize), and “(meth)acryl” means acryl and methacryl.

### 1. Acrylic Rubber-Reinforced Vinyl-Based Resin [A1]

The acryl-based rubbery polymer [a1] using for forming this acrylic rubber-reinforced vinyl-based resin [A1] is not particularly limited so long as it is a (co)polymer obtained by a monomer containing a (meth)acrylic acid alkyl ester.

The above-mentioned monomer preferably comprises an acrylic acid alkyl ester whose carbon number of the alkyl group is in the range from 1 to 12 (hereinafter, referred to as “acrylic acid alkyl ester (m1)”).

Example of the acrylic acid alkyl ester (m1) includes methyl acrylate, ethyl acrylate, n-propyl acrylate, i-propyl acrylate, n-butyl acrylate, i-butyl acrylate, tert-butyl acrylate, amyl acrylate, n-hexyl acrylate, n-octyl acrylate, 2-ethylhexyl acrylate, dodecyl acrylate, cyclohexyl acrylate, phenyl acrylate, benzyl acrylate and the like. Among these compounds, n-butyl acrylate and 2-ethylhexyl acrylate are preferred. Additionally, the acrylic acid alkyl ester (m1) may be used alone or in combination of two or more.

The above-mentioned acryl-based rubbery polymer [a1] may be a homopolymer obtained by using one type of the above-mentioned acrylic acid alkyl ester (m1) or be a copolymer obtained by using two or more types thereof. In addition, it may be also a copolymer obtained by using one or more types of the acrylic acid alkyl ester (m1) and one or more types of a compound (m2) which is copolymerizable with this acrylic acid alkyl ester (m1). Further, it may be also a copolymer obtained by using one or more types of the acrylic acid alkyl ester (m1), one or more types of the compound (m2) and one or more types of a multifunctional vinyl compound (m3).

The compound (m2) is not particularly limited so long as it is capable of copolymerizing with the above-mentioned acrylic acid alkyl ester (m1) and it does not include the multifunctional vinyl compound (m3), however, a monofunctional aromatic vinyl compound, a monofunctional cyanidated vinyl compound, a diene compound and the like may be used. These may be used alone or in combination of two or more.

Example of the monofunctional aromatic vinyl compound includes styrene, a-methyl styrene, o-methyl styrene, p-methyl styrene, vinyl toluene, β-methyl styrene, ethyl styrene, p-tert-butyl styrene, vinyl xylene, vinyl naphthalene and the like. Among these, styrene is preferable. Additionally, these compounds may be used alone or in combination of two or more.

Example of the cyanidated vinyl compound includes acrylonitrile, methacrylonitrile, ethacrylonitrile and the like. Among these, acrylonitrile is preferable. Additionally, these compounds may be used alone or in combination of two or more.

Example of the diene compound includes butadiene, isoprene and the like. These may be used alone or in combination of two or more.

Moreover, the multifunctional vinyl compound (m3) is not particularly limited so long as it has two or more vinyl groups in its molecule, however, a bifunctional aromatic vinyl compound such as divinyl benzene, divinyl toluene, diallyl phthalate and bis (acryloyloxyethyl)ether of Bisphenol A; a bifunctional(meth)acrylic acid ester such as allyl(meth)acrylate, 1,6-hexanediol di(meth)acrylate, ethylene glycol di(meth)acrylate, neopentyl glycol di(meth)acrylate, triethylene glycol di(meth)acrylate, 3-methyl pentanediol di(meth)acrylate and trimethylol propane di(meth)acrylate; a trifunctional (meth)acrylic acid ester such as trimethylol propane tri(meth)acrylate and pentaerythritol tri(meth)acrylate; a (meth)acrylate of a polyalocohol such as pentaerythritol tetra(meth)acrylate, pentaerythritol penta(meth)acrylate, pentaerythritol hexa(meth)acrylate and (poly)ethyleneglycol di(meth)acrylate; diallyl maleate, diallyl fumalate, triallyl cyanulate, triallyl isocyanulate and the like may be used. Among these compounds, allyl methacrylate and triallyl cyanulate are preferred. Additionally, the multifunctional vinyl compound (m3) may be used alone or in combination of two or more.

The above-mentioned acryl-based rubbery polymer [a1] is preferably one obtained by copolymerization using the above-mentioned compounds (m1), (m2) and (m3) in specific amounts as follows.

The acrylic acid alkyl ester (m1) and the compound (m2) are used in amounts preferably from 60 to 100% by mass and from 0 to 40% by mass, more preferably 70 to 100% by mass and 0 to 30% by mass, and further preferably 80 to 100% by mass and 0 to 20% by mass, respectively, based on 100% by mass of the total of these compounds.

Additionally, the multifunctional vinyl compound (m3) is used in an amount preferably from 0.1 to 10 parts by mass, more preferably 0.1 to 8 parts by mass and further 0.15 to 7 parts by mass based on 100 parts by mass of the total of the acrylic acid alkyl ester (m1) and the compound (m2). Setting the amounts of the compounds to be used to the above ranges leads to a polymer component for forming the acrylic rubber-reinforced vinyl-based resin [A1] suitable in a molding material for welding applicable to all of vibration welding, hot plate welding and laser welding and in a molding material for lamp-housing.

The above-mentioned acryl-based rubbery polymer [a1] may be batch polymerized in the presence of the total amount of the above-mentioned compounds (m1), (m2) and (m3), and may be multi-step polymerized by using them divisionally within the above-mentioned preferable range. In the latter case, for example, the acryl-based rubbery polymer can be produced by a two-step polymerization. The method is as follows.

The acryl-based rubbery polymer by the two-step polymerization may be one that is obtained by comprising first step for copolymerizing an acrylic acid alkyl ester (m11) having an alkyl group whose carbon number is in the range from 1 to 12, a compound (m21) which is copolymerizable with the acrylic acid alkyl ester (m11) and a multifunctional vinyl compound (m31) at a polymerization conversion rate of 85% or higher, and second step for copolymerizing an acrylic acid alkyl ester (m12) having an alkyl group whose carbon number is in the range from 1 to 12, a compound (m22) which is copolymerizable with the acrylic acid alkyl ester (m12) and a multifunctional vinyl compound (m32) in the presence of the copolymer obtained by the first step at a polymerization conversion rate of 85% or higher.

Each of the above-mentioned compound (m21) and compound (m22) is a compound which is capable of copolymerizing with the acrylic acid alkyl ester (m11) or (m12) and does not include the multifunctional vinyl compound (m31) or (m32).

It is noted that the above-mentioned acrylic acid alkyl ester (m11) and (m12), compound (m21) and (m22), and multifunctional vinyl compound (m31) and (m32) may be used as the above-mentioned acrylic acid alkyl ester (m1), compound (m2) and multifunctional vinyl compound (m3), respectively exemplified in above. Additionally, regarding these starting materials, compounds to be used in the first step and compounds to be used in the second step may be same or different.

Amounts to be used of the acrylic acid alkyl ester (m11), compound (m21) and multifunctional vinyl compound (m31) in the first step, and amounts to be used of the acrylic acid alkyl ester (m12), compound (m22) and multifunctional vinyl compound (m32) in the second step are as described below.

In the first step, the total amount to be used of the acrylic acid alkyl ester (m11) and compound (m21) is preferably in the range from 50 to 90% by mass, more preferably 60 to 90% by mass and further preferably 65 to 85% by mass based on 100% by mass of the total amount of the above-mentioned acrylic acid alkyl ester (m11) and (m12), and compound (m21) and (m22), the amount to be used of the above-mentioned multifunctional vinyl compound (m31) is preferably in the range from 0.01 to 0.3 part by mass, more preferably from 0.05 to 0.25 part by mass and further preferably from 0.08 to 0.20 part by mass based on 100 parts by mass of the total amount of the above-mentioned acrylic acid alkyl ester (m11) and compound (m21), and in the second step, the total amount to be used of the acrylic acid alkyl ester (m12) and compound (m22) is preferably in the range from 10 to 50% by mass, more preferably 10 to 40% by mass and further preferably 15 to 35% by mass based on 100% by mass of the total amount of the above-mentioned acrylic acid alkyl ester (m11) and (m12), and compound (m21) and (m22), the amount to be used of the above-mentioned multifunctional vinyl compound (m32) is preferably in the range from 0.5 to 10 parts by mass, more preferably from 1 to 8 parts by mass and further preferably from 2 to 7 parts by mass based on 100 parts by mass of the total amount of the above-mentioned acrylic acid alkyl ester (m12) and compound (m22).

Polymer obtained by the method comprising the first and second steps is estimated to be one having a multilayer structure such as core-shell structure. That is, a core portion is formed in the first step and then a shell portion is formed in the second step. Comparing amounts of the multifunctional vinyl compounds used in the first and second steps, the ratio in the second step is higher and the obtained acryl-based rubbery polymer wherein the shell portion formed by the second step is harder than the core portion formed by the first step is estimated.

When the above-mentioned acryl-based rubbery polymer [a1] is produced by batch polymerization and by multi-step polymerization, it is preferable that emulsion polymerization is applied.

The emulsion polymerization is usually performed while agitating and heating a mixture containing a monomer, an emulsifier, a polymerization initiator and water. Into the reaction system, a molecular weight adjusting agent, a chain-transfer agent, an electrolyte and the like may be added.

Example of the emulsifier includes an alkyl sulfonate such as alkane sulfonate, alkylbenzene sulfonate and naphtharene sulfonate; an alkyl sulfate; a polyoxyethylene alkylether sulfate; a polyoxyethylene alkylether; an alkyl sulfosuccinate; polyoxyethylene fatty acid ester; a sorbitan fatty acid ester; a glycerin fatty acid ester; an alkyl phosphate; a rosinate and the like. These may be used alone or in combination of two or more.

The above-mentioned rosinate is an alkali metal salt of rosin acid (usually containing abietic acid mainly) such as gum rosin, wood rosin, tall oil rosin, dismutated rosin obtained by dismutation reaction using these, and purified rosin, and is usually a sodium salt or a potassium salt.

The above-mentioned emulsifier is used usually in an amount from 0.1 to 20 parts by mass and preferably 0.5 to 5 parts by mass based on 100 parts by mass of the total amount of the monomers to be used.

Example of the polymerization initiator includes an organic peroxide such as cumene hydroperoxide, diisopropylbenzene hydroperoxide, paramenthane hydroperoxide, benzoyl peroxide, lauroyl peroxide, tert-butyl peroxylaurate and tert-butylperoxy monocarbonate; an azo compound such as azobisisobutyronitrile; a persulfate such as potassium persulfate, and the like. These may be used alone or in combination of two or more. The above-mentioned polymerization initiator may be added into the reaction system all at once or continuously or divisionally. Additionally, the above-mentioned polymerization initiator is used usually in an amount from 0.001 to 5 parts by mass and preferably from 0.01 to 3 parts by mass based on 100 parts by mass of the total amount of the monomers to be used.

Example of the molecular weight adjusting agent includes a mercaptan such as n-hexyl mercaptan, n-octyl mercaptan, n-dodecyl mercaptan, tert-dodecyl mercaptan, 2-mercapt ethanol, pentaerythritol tetrakis(β-mercapt propionate) and limonene dimercaptan, n-dodecyl thiol acetate, 2-ethylhexyl thioglycolate and the like. These may be used alone or in combination of two or more.

The above-mentioned molecular weight adjusting agent is used usually in an amount from 0 to 5 parts by mass and preferably from 0 to 2 parts by mass based on 100 parts by mass of the total amount of the monomers to be used.

It is noted that the mercaptan in the above-mentioned molecular weight adjusting agent can be used as a chain-transfer agent.

Example of the chain-transfer agent includes, in addition to the mercaptan described above, tetraethyl thiuramsulfide, acrolein, methacrolein, allyl alcohol, 2-ethylhexyl thioglycol and the like.

The above-mentioned chain-transfer agent is used usually in an amount from 0 to 5 parts by mass and preferably from 0 to 3 parts by mass based on 100 parts by mass of the total amount of the monomers to be used.

In the case emulsion polymerization is performed, the polymerization temperature is usually in the range from 10° C. to 95° C., preferably from 30° C. to 90° C., and more preferably from 35° C. to 85° C.

The gel content of the above-mentioned acryl-based rubbery polymer [a1] is less than 70%, preferably 30 to 69.5% and more preferably 45 to 69%. This range of the gel content leads to a polymer component for forming the acrylic rubber-reinforced vinyl-based resin [A1], which is useful as a molding material for welding suitable for vibration welding, hot plate welding and laser welding. This gel content may be controlled by selecting type and amount of the multifunctional vinyl compound to be used, type and amount of the molecular weight adjusting agent to be used, polymerization time, polymerization temperature, polymerization conversion rate and the like appropriately.

The measuring method of the gel content is described below.

At first, 1 gram of the acryl-based rubbery polymer [a1] is added into 20 mililiter of toluene and stirred at 1,000 rpm for 2 hours using an agitator. Then, centrifugal separation is performed for one hour using a centrifugal separator (number of revolutions: 22,000 rpm) to obtain an insoluble component and a soluble component. The insoluble component obtained is massed (its mass is referred to as W1 gram), and further, after the insoluble component is dried, it is massed (its mass is referred to as W2 gram), and the gel content can be calculated by the following equation:

Gel content (%)=[W2(g)/1(g)]×100

The volume-average particle diameter of the above-mentioned acryl-based rubbery polymer [a1] is preferably in the range from 40 to 190 nm, more preferably 50 to 170 nm and further preferably 60 to 150 nm. If the volume-average particle diameter is in the above range, the smoothness of the surface in the case of forming a molded article is excellent and is also excellent in luminance.

In addition, the degree of swelling in toluene of the above-mentioned acryl-based rubbery polymer [a1] is preferably in the range from 6 to 20, more preferably 7 to 20 and further preferably 9 to 18. If the degree of swelling in toluene is in the above range, a polymer component for forming the acrylic rubber-reinforced vinyl-based resin [A1], which is useful as a molding material for welding and as a molding material for forming a lamp-housing suitable for vibration welding, hot plate welding and laser welding. This degree of swelling in toluene can be calculated by the following equation, using the mass of the insoluble component before drying (W1 gram) and the mass thereof after drying (W2 gram) that are obtained in calculating the above-mentioned gel content.

Degree of swelling in toluene=[W1(g)/W2(g)]

The above-mentioned acryl-based rubbery polymer [a1] may be used alone or in combination of two or more.

The above-mentioned acryl rubber-reinforced vinyl-based resin [A1] is one obtained by polymerizing a vinyl-based monomer [b1] containing an aromatic vinyl compound and a cyanidated vinyl compound in the presence of the above-mentioned acryl-based rubbery polymer [a1].

The example of the aromatic vinyl compound includes styrene, a-methyl styrene, o-methyl styrene, p-methyl styrene, vinyl toluene, vinyl xylene, ethyl styrene, dimethyl styrene, methyl-a-methyl styrene, p-tert-butyl styrene, vinyl naphthalene, monobromostyrene, dibromostyrene, tribromostyrene, fluorostyrene and the like. Among these, styrene and a-methyl styrene are preferred. Additionally, these compounds may be used alone or in combination of two or more.

Further, the example of the above-mentioned cyanidated vinyl compound includes acrylonitrile, methacrylonitrile, ethacrylonitrile, fumaronitrile and the like. Among these, acrylonitrile is preferable. Additionally, these compounds may be used alone or in combination of two or more.

The above-mentioned vinyl-based monomer [b1] may contain, besides the above-mentioned aromatic vinyl compound and cyanidated vinyl compound, other compounds capable of copolymerizing with these. As the other compounds, a (meth)acrylic acid alkyl ester, a maleimide compound, an unsaturated compound having a functional group (for example, unsaturated acid, unsaturated compound having an epoxy group, unsaturated compound having a hydroxy group, unsaturated compound having an oxazoline group, unsaturated compound having an acid anhydride group and the like) and the like can be used. These may be used alone or in combination of two or more.

The example of the (meth)acrylic acid alkyl ester includes methyl(meth)acrylate, ethyl(meth)acrylate, propyl(meth)acrylate, butyl(meth)acrylate, amyl(meth)acrylate, hexyl(meth)acrylate, octyl(meth)acrylate, 2-ethylhexyl(meth)acrylate, cyclohexyl(meth)acrylate, phenyl(meth)acrylate, benzyl(meth)acrylate and the like. These compounds may be used alone or in combination of two or more.

The example of the unsaturated acid includes (meth)acrylic acid, itaconic acid, maleic acid and the like. These compounds may be used alone or in combination of two or more.

The example of the maleimide compound includes maleimide, N-methyl maleimide, N-butyl maleimide, N-phenyl maleimide, N-cyclohexyl maleimide and the like. These compounds may be used alone or in combination of two or more. In addition, an introduction of the monomer unit of a maleimide compound into a polymer can be applied to an imidization after (co)polymerization using maleic anhydride.

The example of the unsaturated compound having an epoxy group includes glycidyl(meth)acrylate, β-methylglycidyl(meth)acrylate, β-ethylglycidyl(meth)acrylate, 3-methyl-3,4-epoxybutyl (meth)acrylate, 3-ethyl-3,4-epoxybutyl(meth)acrylate, 4-methyl-4,5-epoxypentyl(meth)acrylate, 2,3-epoxy cyclohexylmethyl(meth)acrylate, 3,4-epoxy cyclohexylmethyl(meth)acrylate, o-vinylbenzyl glycidyl ether, m-vinylbenzyl glycidyl ether, p-vinylbenzyl glycidyl ether, 2-vinylcyclohexene oxide, 3-vinylcyclohexene oxide, 4-vinylcyclohexene oxide, allyl glycidyl ether and the like. These compounds may be used alone or in combination of two or more.

The example of the unsaturated compound having a hydroxyl group includes 3-hydroxy-1-propene, 4-hydroxy-1-butene, cis-4-hydroxy-2-butene, trans-4-hydroxy-2-butene, 3-hydroxy-2-methyl-1-propene, 2-hydroxyethyl(meth)acrylate, 2-hydroxypropyl(meth)acrylate, hydroxycyclohexyl(meth)acrylate, N-(4-hydroxyphenyl)maleimide and the like. These compounds may be used alone or in combination of two or more.

The example of the unsaturated compound having an oxazoline group includes vinyl oxazoline and the like. These compounds may be used alone or in combination of two or more.

The example of the unsaturated compound having an acid anhydride group includes maleic anhydride, itaconic anhydride, citraconic anhydride and the like. These compounds may be used alone or in combination of two or more.

It is preferable that the aromatic vinyl compound and the cyanidated vinyl compound are mainly used as the above-mentioned vinyl-based monomer [b1], and total amount of these compounds is preferably 75% by mass or more, more preferably 80% by mass or more, and further preferably 90% by mass or more with respect to the total amount of the vinyl-based monomer [b1]. Moreover, the respective amounts to be used of the aromatic vinyl compound and the cyanidated vinyl compound are preferably in the range from 5 to 95% by mass and from 5 to 95% by mass, respectively, and more preferably 50 to 90% by mass and 10 to 50% by mass, respectively, based on 100% by mass of the total of these.

The production method of the acrylic rubber-reinforced vinyl-based resin [A1] is not particularly limited and includes emulsion polymerization, bulk polymerization, solution polymerization, suspension polymerization and the like. Among these, emulsion polymerization is preferred. The amounts of the acryl-based rubbery polymer [a1] and the vinyl-based monomer [b1] to be used are preferably in the range from 5 to 95% by mass and from 5 to 95% by mass, respectively, and more preferably 30 to 80% by mass and 20 to 70% by mass, respectively, based on 100% by mass of the total of these.

In the case of producing the acrylic rubber-reinforced vinyl-based resin [A1] by emulsion polymerization, an emulsifier, a polymerization initiator, a molecular weight adjusting agent, a chain-transfer agent, an electrolyte, water and the like similar to the case in producing the above-mentioned acryl-based rubbery polymer [a1] by emulsion polymerization may be used. The types of these agents are as exemplified above.

Regarding the polymerization initiator, a redox-type initiator combined the above-mentioned organic peroxide with a reducing agent such as sugar-containing pyrophosphoric acid formulation and sulfoxylate formulation may be used in addition to the above compounds.

The amount of the emulsifier to be used is preferably in the range from 0.1 to 5 parts by mass and more preferably 0.5 to 3 parts by mass based on 100 parts by mass of the vinyl-based monomer [b1].

The amount of the polymerization initiator to be used is preferably in the range from 0.01 to 5 parts by mass and more preferably 0.1 to 3 parts by mass based on 100 parts by mass of the vinyl-based monomer [b1]. This polymerization initiator may be added to the reaction system all at once or continuously.

The amount of the molecular weight adjusting agent to be used is preferably in the range from 0 to 3 parts by mass and more preferably 0 to 1 part by mass based on 100 parts by mass of the vinyl-based monomer [b1].

The amount of the chain-transfer agent to be used is preferably in the range from 0 to 5 parts by mass and more preferably 0.01 to 2 parts by mass based on 100 parts by mass of the vinyl-based monomer [b1].

When the acrylic rubber-reinforced vinyl-based resin [A1] is subjected to emulsion polymerization to produce, the vinyl-based monomer [b1] may be added to the system all at once in the presence of whole of the acryl-based rubbery polymer [a1] or may be added to the system divisionally or continuously. In addition, the polymerization may be started by adding all of the vinyl-based monomer [b1] to the system in the presence of a part of the acryl-based rubbery polymer [a1] and the rest of the acryl-based rubbery polymer [a1] may be added in the course of the polymerization, or be started by adding the vinyl-based monomer [b1] divisionally or continuously to the system and the rest of the acryl-based rubbery polymer [a1] may be added in the course of the polymerization.

In the case emulsion polymerization is performed, the polymerization temperature is usually in the range from 10° C. to 95° C., preferably from 30° C. to 90° C., and more preferably from 35° C. to 85° C.

In the case of isolating the acrylic rubber-reinforced vinyl-based resin [A1] in the latex obtained by polymerization of the vinyl-based monomer [b1] in the presence of the acryl-based rubbery polymer [a1], a coagulant is usually added. After that, the coagulated acrylic rubber-reinforced vinyl-based resin [A1] is subjected to filtration, rinsing appropriately and further drying to obtain uniform powder. The coagulant includes an inorganic salt such as calcium chloride, magnesium sulfate and magnesium chloride; an acid such as sulfuric acid, hydrochloric acid and acetic acid, and the like.

In the case of producing the acrylic rubber-reinforced vinyl-based resin [A1] by solution polymerization, a solvent, a polymerization initiator, a chain-transfer agent and the like may be usually used. The acrylic rubber-reinforced vinyl-based resin [A1] may also be produced by using no polymerization initiators.

The solvent may be an inactive solvent for polymerization used in publicly known radical polymerization, and includes an aromatic hydrocarbon such as ethylbenzene and toluene; a ketone such as methylethylketone and acetone; a halogenated hydrocarbon such as dichloromethylene and carbon tetrachloride; acetonitrile, dimethylformamide, N-methylpyrrolidone and the like.

The polymerization initiator includes an organic peroxide such as a ketone peroxide, a dialkyl peroxide, a diacyl peroxide, a peroxy ester and a hydroperoxide.

The chain-transfer agent includes a mercaptan, a-methyl styrene dimer, a terpinolene and the like.

The production condition for the acrylic rubber-reinforced vinyl-based resin [A1] by solution polymerization may be selected depending on types of the vinyl-based monomer [b1], the polymerization initiator and the like to be used. Regarding the method of using the acryl-based rubbery polymer [a1] and the vinyl-based monomer [b1], the vinyl-based monomer [b1] may be added to the system all at once in the presence of whole of the acryl-based rubbery polymer [a1] or may be added to the system divisionally or continuously. In addition, the polymerization may be started by adding all of the vinyl-based monomer [b1] to the system in the presence of a part of the acryl-based rubbery polymer [a1] and the rest of the acryl-based rubbery polymer [a1] may be added in the course of the polymerization, or be started by adding the vinyl-based monomer [b1] divisionally or continuously to the system and the rest of the acryl-based rubbery polymer [a1] may be added in the course of the polymerization.

In the case solution polymerization is performed, the polymerization temperature is usually in the range from 0° C. to 150° C.

Also in production the bulk polymerization and the suspension polymerization, publicly known methods can be applied. The polymerization initiator, the chain-transfer agent and the like used in these method may be the same compounds exemplified in the solution polymerization.

When the acrylic rubber-reinforced vinyl-based resin [A1] is produced by emulsion polymerization, solution polymerization and the like usually comprises a copolymer wherein a (co)polymer of the vinyl-based monomer [b1] is grafted to the acryl-based rubbery polymer [a1], and a non-grafted component wherein a (co)polymer of the vinyl-based monomer [b1] is not grafted to the acryl-based rubbery polymer [a1], namely, a (co)polymer of the vinyl-based monomer [b1].

The graft ratio of the above-mentioned acrylic rubber-reinforced vinyl-based resin [A1] is preferably in the range from 30 to 200%, more preferably 40 to 150% and further preferably 50 to 110%. If the graft ratio is in above range, the acrylic rubber-reinforced vinyl-based resin which is useful as a molding material for welding and as a molding material for forming a lamp-housing suitable for vibration welding, hot plate welding and laser welding. The graft ratio can be calculated by the following equation.

Graft ratio (%)={(S−T)/T}×100

In the equation, S denotes a mass (g) of the insoluble component obtained by adding 1 gram of the acrylic rubber-reinforced vinyl-based resin [A1] into 20 mililiter of acetonitrile, vibrating for 2 hours by a vibrator, centrifuging for 60 minutes by a centrifugal separator (number of revolutions: 23,000 rpm) and isolating from an insoluble component and a soluble component, T denotes a mass (g) of the acryl-based rubbery polymer [a1] contained in 1 gram of the acrylic rubber-reinforced vinyl-based resin [A1].

Further, the limiting viscosity [η] (measured at a temperature of 25° C. using methylethylketone as a solvent) of the acetonitrile-soluble component contained in the acrylic rubber-reinforced vinyl-based resin is preferably from 0.1 to 1.0 dl/g, more preferably 0.1 to 0.8 dl/g, and further preferably 0.15 to 0.70 dl/g.

### 2. (Co)polymer [A2]

The vinyl-based monomer [b2] using for forming this (co)polymer [A2] is preferably one or more among an aromatic vinyl compound, a cyanidated vinyl compound, a (meth)acrylic acid alkyl ester, a maleimide compound and an unsaturated compound having a functional group (for example, unsaturated acid, unsaturated compound having an epoxy group, unsaturated compound having a hydroxyl group, unsaturated compound having an oxazoline group, unsaturated compound having an acid anhydride group and the like). The particularly preferred is one or more among an aromatic vinyl compound, a cyanidated vinyl compound, a (meth)acrylic acid alkyl ester and a maleimide compound. Each of the above compounds may be the exemplified as the vinyl-based monomer [b1] for manufacturing the above-mentioned acrylic rubber-reinforced vinyl-based resin [A1].

Example of the above-mentioned (co)polymer [A2] is as follows. These may be used alone or in combination of two or more.
(1) styrene acrylonitrile copolymer
(2) styrene acrylonitrile methyl methacrylate copolymer
(3) a-methylstyrene.acrylonitrile copolymer
(4) a-methylstyrene.acrylonitrile methyl methacrylate copolymer
(5) styrene-a-methylstyrene.acrylonitrile copolymer
(6) styrene.N-phenyl maleimide copolymer
(7) styrene.acrylonitrile.N-phenyl maleimide copolymer
(8) methyl methacrylate.styrene copolymer
(9) methyl methacrylate.a-methylstyrene copolymer
(10) polystyrene
(11) poly a-methylstyrene
(12) poly methyl methacrylate

### 3. Molding Material for Welding

The molding material for welding of the present invention (hereinafter, referred to as “the present molding material”) comprises an acrylic rubber-reinforced vinyl-based resin [A1], or a mixture consisting of this acrylic rubber-reinforced vinyl-based resin [A1] and a (co)polymer [A2].

Therefore, the present molding material may be consisting of only the above-mentioned acrylic rubber-reinforced vinyl-based resin [A1], or of only the above-mentioned mixture, or of a mixture of these and other component (polymer, additive and the like).

The content of the acryl-based rubbery polymer [a1] in the present molding material in all of the above-mentioned embodiments is in the range from 5 to 40% by mass, preferably 5 to 35% by mass and more preferably 10 to 30% by mass. The content ranging this leads to a molding material for welding and a molding material for lump housing, which are useful as a molding material for welding suitable for vibration welding, hot plate welding and laser welding.

The present molding material may comprise a polymer (resin), an additive and the like for the purpose of improving properties of the present invention.

The example of the polymer (resin) includes a rubber-reinforced resin such as ABS resin, HIPS resin, AES resin, silicone rubber-reinforced resin, hydrogenated rubber-reinforced resin and ASA resin (excluding the acrylic rubber-reinforced vinyl-based resin [A1]); a olefin-based resin such as polyethylene, polypropyrene, ionomer, ethylene.vinyl acetate copolymer, ethylene-vinyl alcohol copolymer, cyclic olefin copolymer and chlorinated polyethylene; a polyamide-based resin such as polyamide 6, polyamide 6,6 and polyamide 6,12: a polyester-based resin such as polyethylene terephtharate (PET), polybutylene terephtharate (PBT) and polynaphtharene terephtharate; a polycarbonate resin; a polyacetal resin; liquid crystal polymer and the like. These may be used alone or in combination of two or more. Among those, a rubber-reinforced resin is preferred.

The amount of the polymer (resin) to be used is preferably in the range from 1 to 30 parts by mass with respect to 100 parts by mass of the total of the polymer component containing the above-mentioned acrylic rubber-reinforced vinyl-based resin [A1], (co)polymer [A2] and the like.

The example of the additive includes a filler, an ultra violet absorber, an antioxidant, a flame retardant, a compatibilizing agent, a thermal stabilizer, a light stabilizer, an antistatic agent, a lubricant, a mold-releasing agent, a coloring agent and the like.

The filler that is composed of a metal (including an alloy), an inorganic compound, a polymer compound and the like may be used. Additionally, one of a composite material comprising two or more of the above material may be used.

The example of the metal includes stainless, aluminum, titanium, copper and the like. The example of the inorganic compound includes an oxide such as alumina and zirconia, a nitride such as silicon nitride and boron nitride, a carbide such as silicon carbide, a carbonate such as calcium carbonate and magnesium carbonate, a sulfate such as calcium sulfate, a silicate such as silica, quartz, glass, calcium silicate, aluminum silicate, kaolin, clay and diatomaceous earth, a nitrate, a phosphate and the like.

The shape of the filler is not also particularly limited, and may be particulate, fiber-like, tabular, bulk and the like. The example of the fiber-like filler includes glass fiber, carbon fiber, silica fiber, silica.alumina fiber, zirconia fiber, boron nitride fiber, silicon nitride fiber, boron fiber, potassium titanate whisker and the like. In addition, the example of the tabular filler includes talc, mica, glass flakes, metal foil and the like.

These may be used alone or in combination of two or more. These fillers may also be used as a reinforcing agent.

The amount of the filler to be used is preferably from 0 to 300 parts by mass and more preferably from 0 to 100 parts by mass with respect to 100 parts by mass of the total of the polymer component containing the above-mentioned acrylic rubber-reinforced vinyl-based resin [A1], (co)polymer [A2] and the like.

The example of the ultra violet absorber includes benzophenones, benzotriazoles, salicylic acid esters, metal complex salts and the like. These may be used alone or in combination of two or more.

The amount of the ultra violet absorber to be used is preferably from 0 to 5 parts by mass and more preferably 0.01 to 3 parts by mass with respect to 100 parts by mass of the total of the polymer component containing the above-mentioned acrylic rubber-reinforced vinyl-based resin [A1], (co)polymer [A2] and the like.

The example of the antioxidant includes hindered amines, hydroquinones, hindered phenols, sulfur-containing compounds and the like. These may be used alone or in combination of two or more.

The amount of the antioxidant is preferably from 0 to 5 parts by mass and more preferably 0.01 to 3 parts by mass with respect to 100 parts by mass of the total of the polymer component containing the above-mentioned acrylic rubber-reinforced vinyl-based resin [A1], (co)polymer [A2] and the like.

The example of the flame retardant includes an organic-based flame retardant, an inorganic-based flame retardant, a reactive flame retardant and the like. These may be used alone or in combination of two or more.

In the case of formulating a flame retardant in the present molding material, it is preferable that a flame retardant auxiliary is used together. The flame retardant auxiliary includes an antimony compound such as diantimony trioxide, diantimony tetraoxide, diantimony pentoxide, sodium antimonite and antimony tartrate, zinc borate, barium metaborate, alumina hydrate, zirconium oxide, ammonium polyphosphate, tin oxide and the like. These may be used alone or in combination of two or more.

The present molding material can be produced by kneading starting components with an extruder, Henschel mixer, Banbury mixer, a kneader, a roll, a feeder ruder or the like. The preferable producing method is a method using an extruder, Henschel mixer or Banbury mixer. Kneading may be initiated after charging all of the starting components or be conducted while charging them dividedly. In latter case, it is preferable that an extruder, Henschel mixer and Banbury mixer are used.

Moreover, a specific shape including pellet may be fabricated by an extruder after kneading by Henschel mixer, Banbury mixer, a kneader and the like.

Regarding the present molding material, the number of stringing observed at the time a test piece which is made of the molding material for welding and has a length of 100 mm, a width of 30 mm and a thickness of 3 mm is released from a heated plate after the test piece is subjected to conditioning at a temperature of 23° C. and at a relative humidity of 50% for 3 hours, and to contacting with the heated plate under a test condition below is 3 pieces or less, preferably 2 pieces or less, more preferably 1 piece or less and particularly zero.

### <Test Conditions>

Temperature of the heated plate; 280° C.
Transfer speed; 200 mm/sec.
Time for contacting the test piece with the heated plate; 15 sec.
Melted length of the test piece; 0.5 mm

Additionally, the deflection temperature (under load) of the present molding material is measured in accordance with ISO75 and is preferably 80° C. or higher, and more preferably 81° C. or higher.

Since the present molding material is excellent in fluidity during melting, a molded article for welding can be easily produced by injection molding method, sheet extrusion method, vacuum molding method, contour extrusion method, compression molding method, hollow molding method, compression molding, differential pressure molding method, blow molding method, foam molding method, gas-injection molding method and the like. This molded article for welding, and a part consisting of the present molding material or other molding material can be easily integrated by a joining method such as vibration welding, hot plate welding and laser welding.

For example, when a housing and a container (such as a fuel tank) that are used in wide field exemplifying daily goods, parts for vehicles, electric/electronic parts, mechanical parts and the like are manufactured, two molded articles which have been previously prepared by splitting into two parts are welded at the respective peripheral portions. In addition, a meter (measuring device) for vehicles and for measuring apparatuses is manufactured by using and welding a meter case (made of the present molding material) having a measuring apparatus therein and a covering body made of usually a transparent resin (acryl-based resin, polycarbonate resin and the like) at the respective peripheral portions. Except for the above-mentioned ones, the present molding material is also suitably used for a molded article for welding such as a hose connector, a cut-off valve, a fuel pump casing, an inlet pipe and the like that are in a variety of fields of industries.

In the case a lamp-housing is manufactured with the present molding material, the above-mentioned molding methods can be applied. A lamp-housing for vehicles (including two-wheelers, four-wheelers and the like) such as housings for head lamp, extensions and housings for high mount stop lamp; lamp-housings for appliance, lamp-housings for measuring apparatuses and the like may be manufactured. Further, a lamp can be produced by joining it with a lens made of a resin such as an acryl-based resin and a polycarbonate resin.

The vibration welding is a welding method that utilizes a frictional heat. A molded article for welding consisting of the present molding material and a part consisting of the present molding material or other molding material are subjected to vibration at an amplitude from about 0.3 to 2.0 mm and at a vibration frequency from about 50 to 110 MHz while pressurizing at a predetermined pressure, and to integration of two parts by melting the resin with occurred frictional heat. This joining is performed with a vibration welding machine and the like in general. When a lamp is manufactured, a lamp-housing and a surface to be joined (or a portion to be joined) of a lens made of a resin are subjected to pressuring at a predetermined pressure to vibrate and to joining by melting the resin with occurred frictional heat.

A hot plate welding is a welding method in which a plate heated to a temperature between 220 and 300° C. is interposed between a molded article for welding consisting of the present molding material and a part consisting of the present molding material or other molding material and in contact with these, the resins of the surfaces to be joined (or portions to be joined) are melted, the heated plate is removed, and both parts are subjected to pressuring to join immediately. When a lamp is manufactured, a heated plate is interposed between a lamp-housing and a surface to be joined (or a portion to be joined) of a lens made of a resin to melt the resins of the surfaces to be joined (or portions to be joined), the heated plate is removed and both parts are subjected to pressuring to join.

Moreover, a laser welding is a method for joining a molded article for welding consisting of the present molding material and a part consisting of the present molding material or other molding material by fitting them, irradiating the outside of a part whose transmission of the laser beam is higher (a molded article for welding made of the present molding material for welding in general) with a laser beam to heat the surface of the part to be joined of the other side by the laser beam passed through a transmittable material and to melt the material, and at the same time, melting a material of the side that the laser beam passed with heat transmission, sequentially. When a lamp is manufactured, a lamp-housing and a surface to be joined (or a portion to be joined) of a lens made of a resin are fitted, a laser beam is radiated to the outside of a part whose transmission of the laser beam is higher among a constituting material of the lamp-housing and a constituting material of the resin made lens, the laser beam passed through a transmittable material heats the surface of the part to be joined of the other side to melt the material, and at the same time, a material of the side that the laser beam passed is molten with heat transmission to join them.

The vibration welding method and the hot plate welding method are preferable as a joining method of a lamp-housing obtained using the present molding material and a lens made of a resin. According a vibration welding method, occurrences of a resin powder, a (string-shaped) burr and the like around the joined portion may be inhibited. In addition, occurrences of a stringing and the like between a heated mold such as heated plate, and the constituting material of the lamp-housing may be inhibited.

Thus lamp obtained is excellent in appearance and impact resistance as an integrated product, since failure phenomena on the joined portion are suppressed. Moreover, since the failure phenomena are slight, the post treatment is not required and the yield in production can be enhanced.

The molded article for welding (lamp-housing and the like) which is manufactured using the present molding material has an excellent smoothness because convexes and concaves hardly exist. Therefore, even if a metal layer (comprising aluminum, chromium or the like) is provided by sputtering method, vacuum deposition method or the like without undercoat treatment for the purpose of forming a metal gloss surface, a reflectable surface of the light and the like, cloudiness on the surface may be inhibited and an excellent gloss surface and a reflectable surface can be obtained. For example, in the case an aluminum vapor-deposited film (thickness of 0.1 nm) and a plasma polymerization film HMDS (1,1,1,3,3,3-hexamethyldisilazane) under the conditions described in the following Example are sequentially formed on a tabular molded article manufactured using the present molding material, the total reflection index may be preferably 80% or higher and more preferably 85% or higher.

The vibration welding method and the hot plate welding method are preferable as a joining method using molded articles for welding obtained with the present molding material and a lens made of a resin. According a vibration welding method, occurrences of a resin powder, a (string-shaped) burr and the like around the joined portion may be inhibited. In addition, occurrences of a stringing and the like between a heated mold such as heated plate, and the molded articles may be inhibited.

### EXAMPLES

The present invention is described in detail hereinafter using examples. The present invention is in no way limited by these examples. In addition, “part” and “%” in the examples are based on mass unless otherwise indicated.

### 1. Evaluating Method

The various evaluation methods used in the present examples are as follows.

### (1) Melt Flow Rate

It was measured in accordance with ASTM-D1238 (240° C., 10 kg). The unit is g/10 min.

### (2) Charpy Impact Strength

It was measured in accordance with ISO179 (room temperature). The unit is kJ/m².

(3) Deflection Temperature under Load

It was measured in accordance with ISO75 (Under load). The unit is 0° C.

### (4) Hot Plate-Weldable Property

The pellets consisting of a molding material were introduced into a molding machine (“IS-25EP” manufactured by Toshiba Machine Co., Ltd.) to melt at a temperature in the range from 220° C. to 250° C. and a test piece for welding with a hot plate having a length of 10 cm, a width of 3 cm and a thickness of 3 mm was molded. This test piece was subjected to conditioning at a temperature of 23° C. and at a relative humidity of 50% for 3 hours, and to contacting with a heated plate under the following conditions using a hot plate welding machine (manufactured by Techno Polymer, Co., Ltd.). The number of pieces of stringing was counted at the time when the test piece was released from the heated plate. The “hot plate-weldable property” was determined by the number of pieces of the stringing.

The judging criteria are as follows.
O: the number of stringing was 3 pieces or less.
X: the number of stringing exceeded over 3 pieces.

### <Conditions in Hot Plate Welding>

Temperature of the heated plate; 280° C.
Transfer speed of the servo motor; 200 mm/sec.
Time for the test piece being in contact with the heated plate; 15 sec.
Melted length of the test piece; 0.5 mm

### (5) Vibration-Weldable Property

The pellets consisting of a molding material were introduced into a molding machine (type name: “IS-170FA” manufactured by Toshiba Machine Co., Ltd.) to melt at a temperature in the range from 220° C. to 260° C and a housing in a predetermined shape was obtained. On the other hand, a methacrylic resin (trade name: “Acrypet VH-4”, manufactured by Mitsubishi Rayon, Co., Ltd.) was melted at a temperature in the range from 220° C. to 270° C. to obtain a transparent plate. The above-mentioned housing and the transparent plate were subjected to vibration welding under the following conditions using a vibration welding machine (type name: “BURANSON 2407” manufactured by Emerson Japan, Ltd.). At that time, the number of the resin powder (the number of a resin powder having a size in the range from about several tens of microns to 2 mm which were generated within the housing and observed visibly) and the number of string-shaped burr (the number of a string-shaped burr having a size of 2 mm or more generated within the housing) were counted. The “vibration-weldable property” was determined by these numbers of the resin powder and the string-shaped burr.

The judging criteria are as follows.
O: the number of string-shaped burr was 5 pieces or less.
X: the number of string-shaped burr was 6 pieces or more.

### <Conditions in Vibration Welding>

Vibration welding was performed under the following conditions when the amount of powder was evaluated.
Half amplitude; 0.5 mm
Initial pressure; 2.0 bar
Initial vibration time; 4.0 sec.
Pressure at second step 4.0 bar
Vibration time at second step; 2.0 sec.

Vibration welding was performed under the following conditions when the amount of string-shaped burr was evaluated.
Half amplitude; 0.5 mm
Initial pressure; 5.0 bar
Initial vibration time; 0.5 sec.
Pressure at second step; 5.0 bar
Vibration time at second step; 2.0 sec.

### (6) Luminance

Sputtering onto the surface of the housing obtained by the above-mentioned vibration welding was carried out under the following conditions with a vacuum depositing apparatus (type name: “VRSP350MD” manufactured by ShinMaywa Industries, Ltd.) to form a vapor-deposited film of aluminum. Subsequently, a plasma polymerization film using HMDS (1,1,1,3,3,3-hexamethyldisilazane) was formed on the surface of this vapor-deposited film under the following conditions.

The luminance was evaluated by measuring the diffusion reflection by irradiating a light with a digital reflection meter (type name: “TR-1100AD” manufactured by Tokyo Denshoku Co., Ltd.). Unit applied is % for all items.

### <Conditions in Sputtering>

Pressure after roughly vacuuming; 5.0 Pa
Pressure after completely vacuuming; 5.0×10⁻³ Pa
Introduced gas; Argon gas at 100 SCCM
Degree of vacuum at the time of film formation; 0.7 Pa
Aluminum Film Thickness; 120 nm

### <Conditions in Plasma Polymerization>

Introduced gas; HMDS at 30 SCCM
Degree of vacuum at the time of polymerization; 1.5 Pa

### 2. Production of Acrylicubber-Reinforced Vinyl-Based Resin [A1]

The acrylic rubber-reinforced vinyl-based resin [A1] was produced by emulsion polymerization using preliminarily prepared latex containing an acryl-based rubbery polymer.

### Production Example 1

### Production of Acrylic Rubber-Reinforced Vinyl-Based Resin [A1-1]

The latex was prepared by polymerization in two steps.

In the first process, 10.0 parts of n-butyl acrylate, 0.02 part of allyl methacrylate, 1.0 part of sodium dodecylbenzene sulfonate, 0.003 part of cumene hydroperoxide, 0.004 part of sodium ethylenediaminetetraacetate, 0.003 part of ferrous sulfate, 0.05 part of sodium formaldehyde sulfoxylate and 180 parts of an ion-exchanged water were charged into a reactor equipped with a reflux condenser, a stirrer, a thermometer and a temperature-controlling device, and the mixture was heated while stirring. Subsequently, the temperature of the reaction system was maintained at 60° C. to polymerize for 80 min. And then, a mixture consisting of 25.0 parts of n-butyl acrylate, 0.05 part of allyl methacrylate and 0.006 part of cumene hydroperoxide was added continuously over the course of 90 minutes and polymerized while maintaining the temperature of the reaction system at 60° C. The polymerization conversion rate was 92%.

Continuously, in the second process, the solution reacted in the first process was used as it is. A mixture consisting of 15.0 parts of n-butyl acrylate, 0.62 part of allyl methacrylate and 0.004 part of cumene hydroperoxide was added into the above solution continuously over the course of 90 minutes and polymerized while maintaining the temperature of the reaction system at 60° C. to obtain a latex (L1) containing an acryl-based rubbery polymer. The polymerization conversion rate was 95%.

The gel content of the acryl-based rubbery polymer was 63%, the volume-average particle diameter was 110 nm, and the degree of swelling in toluene was 13.

After that, 50 parts (solid content) of the above-mentioned latex (L1), 0.2 part of sodium dodecylbenzene sulfonate and 0.15 part of sodium formaldehyde sulfoxylate were charged into a reactor equipped with a reflux condenser, a stirrer, a thermometer and a temperature controlling device. The temperature of the mixture was maintained at 60° C. and then, the mixture (i) consisting of 37.8 parts of styrene, 12.2 parts of acrylonitrile and 0.25 part of tert-dodecyl mercaptan and the mixture (ii) consisting of 0.2 part of tert-butyl hydroperoxide, 0.6 part of sodium dodecylbenzene sulfonate and 12 parts of an ion-exchanged water were added continuously over the course of 5 hours and polymerized while maintaining the temperature of the reaction system at 60° C. After the addition was terminated, the reaction system was left for one hour to obtain a latex containing an acrylic rubber-reinforced vinyl-based resin [A1-1]. The polymerization conversion rate was 95%.

The acrylic rubber-reinforced vinyl-based resin [A1-1] was isolated by adding calcium chloride to the above-mentioned latex to coagulate and filtering. After that, a powder was obtained by washing with water and drying. The graft ratio was 66%.

### Production Example 2

### Production of Acrylic Rubber-Reinforced Vinyl-Based Resin [A1-2]

The latex was prepared by polymerization in two steps.

In the first process, 10.0 parts of n-butyl acrylate, 0.005 part of allyl methacrylate, 1.0 part of sodium dodecylbenzene sulfonate, 0.003 part of cumene hydroperoxide, 0.004 part of sodium ethylenediaminetetraacetate, 0.003 part of ferrous sulfate, 0.05 part of sodium formaldehyde sulfoxylate and 180 parts of an ion-exchanged water were charged into a reactor equipped with a reflux condenser, a stirrer, a thermometer and a temperature-controlling device, and the mixture was heated while stirring. Subsequently, the temperature of the reaction system was set to 60° C. to polymerize for 80 min. And then, a mixture consisting of 25.0 parts of n-butyl acrylate, 0.013 part of allyl methacrylate and 0.006 part of cumene hydroperoxide was added continuously over the course of 90 minutes and polymerized while maintaining the temperature of the reaction system at 60° C. The polymerization conversion rate was 91%.

Continuously, in the second process, the solution reacted in the first process was used as it is. A mixture consisting of 15.0 parts of n-butyl acrylate, 0.62 part of allyl methacrylate and 0.004 part of cumene hydroperoxide was added into the above solution continuously over the course of 90 minutes and polymerized while maintaining the temperature of the reaction system at 60° C. to obtain a latex (L2) containing an acryl-based rubbery polymer. The polymerization conversion rate was 95%.

The gel content of the acryl-based rubbery polymer was 58%, the volume-average particle diameter was 105 nm, and the degree of swelling in toluene was 12.

After that, 50 parts (solid content) of the above-mentioned latex (L2), 0.2 part of sodium dodecylbenzene sulfonate and 0.15 part of sodium formaldehyde sulfoxylate were charged into a reactor equipped with a reflux condenser, a stirrer, a thermometer and a temperature controlling device. The temperature of the mixture was maintained at 60° C. and then, the mixture (i) consisting of 37.8 parts of styrene, 12.2 parts of acrylonitrile and 0.25 part of tert-dodecyl mercaptan and the mixture (ii) consisting of 0.2 part of tert-butyl hydroperoxide, 0.6 part of sodium dodecylbenzene sulfonate and 12 parts of an ion-exchanged water were added continuously over the course of 5 hours and polymerized while maintaining the temperature of the reaction system at 600 C. After the addition was terminated, the reaction system was left for one hour to obtain a latex containing an acrylic rubber-reinforced vinyl-based resin [A1-2]. The polymerization conversion rate was 95%.

The acrylic rubber-reinforced vinyl-based resin [A1-2] was collected in a similar way to the above-mentioned Production Example 1 to obtain as a powder. The graft ratio was 62%.

### Production Example 3

### Production of Acrylic Rubber-Reinforced Vinyl-Based Resin [A1-3]

The latex was prepared by polymerization in two steps.

In the first process, 10.0 parts of n-butyl acrylate, 0.5 part of allyl methacrylate, 1.0 part of sodium dodecylbenzene sulfonate, 0.003 part of cumene hydroperoxide, 0.004 part of sodium ethylenediaminetetraacetate, 0.003 part of ferrous sulfate, 0.05 part of sodium formaldehyde sulfoxylate and 180 parts of an ion-exchanged water were charged into a reactor equipped with a reflux condenser, a stirrer, a thermometer and a temperature-controlling device, and the mixture was heated while stirring. Subsequently, the temperature of the reaction system was set to 60° C. to polymerize for 80 min. And then, a mixture consisting of 25.0 parts of n-butyl acrylate, 0.013 part of allyl methacrylate and 0.006 part of cumene hydroperoxide was added continuously over the course of 90 minutes and polymerized while maintaining the temperature of the reaction system at 60° C. The polymerization conversion rate was 91%.

Continuously, in the second process, the solution reacted in the first process was used as it is. A mixture consisting of 15.0 parts of n-butyl acrylate, 0.62 part of allyl methacrylate and 0.004 part of cumene hydroperoxide was added into the above solution continuously over the course of 90 minutes and polymerized while maintaining the temperature of the reaction system at 60° C. to obtain a latex (L3) containing an acryl-based rubbery polymer. The polymerization conversion rate was 95%.

The gel content of the acryl-based rubbery polymer was 80%, the volume-average particle diameter was 100 nm, and the degree of swelling in toluene was 5.

After that, 40 parts (solid content) of the above-mentioned latex (L3), 1 part of sodium dodecylbenzene sulfonate and 150 parts of an ion-exchanged water were charged into a reactor equipped with a reflux condenser, a stirrer, a thermometer and a temperature controlling device. The reaction system was subjected to replacing with nitrogen, and then 0.02 part of sodium ethylenediaminetetraacetate, 0.005 part of ferrous sulfate and 0.3 part of sodium formaldehyde sulfoxylate were added and heated to 60° C. while stirring. On the other hand, 0.2 part of cumeme hydroperoxide was dissolved in 60 parts of a mixture of acrylonitrile and styrene (mass ratio: 25/75) and replaced with nitrogen. The mixture containing these monomers was added into the reaction system at a certain flow rate over the course of 3 hours and polymerized while maintaining the temperature of the reaction system at 60° C. to obtain a latex containing an acrylic rubber-reinforced vinyl-based resin [A1-3]. The polymerization conversion rate was 97%.

The acrylic rubber-reinforced vinyl-based resin [A1-3] was collected in a similar way to the above-mentioned Production Example 1 to obtain as a powder. The graft ratio was 85%.

### 3. (Co)polymer [A2]

The following two polymers were used as the (co)polymer [A2].

### 3-1. Copolymer (A2-1)

It is a copolymer consisting of styrene unit in an amount of 75% and acrylonitrile unit in an amount of 25%, and has a limiting viscosity [η] (measured in methylethylketone at 30° C.) of 0.6 dl/g.

### 3-2. Copolymer (A2-2)

It is a copolymer consisting of a-methylstyrene unit in an amount of 70% and acrylonitrile unit in an amount of 30%, and has a limiting viscosity [η] (measured in methylethylketone at 30° C.) of 0.4 dl/g.

### 4. Manufacturing and Evaluation of Molding Material for Welding

### Examples 1-2 and Comparative Example 1

The components described above were introduced into a Henschel mixer at the blending ratio shown in Table 1, and mixed for 3 min. After that, it was melted and kneaded using a screw-type uniaxial extruder having a diameter of 40 mm (setting temperature of cylinder: 220° C.), and pellets (molding material for welding) were obtained. Evaluation on the above-mentioned items was performed using these pellets and the results were indicated in Table 1.

TABLE 1

| | | | | | | Comparative |
|---|---|---|---|---|---|---|
| | | | | Example 1 | Example 2 | Example 1 |
| Molding | Amount | Acrylic rubber-reinforced | A1-1 | 33 | | |
| material | (part) | vinyl-based resin | A1-2 | | 33 | |
| for welding | | | A1-3 | | | 41 |
| | | Copolymer | A2-1 | 30 | 30 | 22 |
| | | | A2-2 | 37 | 37 | 37 |

| | | | | |
|---|---|---|---|---|
| Property | Content of acryl-based rubbery polymer (%) | 17.4 | 17.4 | 16.9 |

| | | | | |
|---|---|---|---|---|
| Result | MFR (g/10 min.) | 24 | 26 | 22 |
| | Charpy impact strength (kJ/m²) | 7 | 8 | 7 |
| | Deflection temperature under load (° C.) | 83 | 83 | 83 |
| | Hot plate-weldable property | ∘ | ∘ | x |
| | Vibration-weldable property | ∘ | ∘ | ∘ |
| | Luminance (%) | 2.8 | 2.9 | 2.8 |

### 5. Effects of Examples

Comparative Example 1 was an example in which the gel content of the acryl-based rubbery polymer used for forming the acrylic rubber-reinforced vinyl-based resin is 70% or more, and was inferior in hot plate-weldable property.

On the other hand, Examples 1 and 2 were excellent in all of hot plate-weldable property, vibration-weldable property and luminance.

### INDUSTRIAL APPLICABILITY

According to the molding material for welding of the present invention, a molded article for welding in predetermined shape may be easily obtained by known molding method such as injection molding method, sheet extrusion method, vacuum molding method, contour extrusion method, compression molding method, hollow molding method, compression molding, differential pressure molding method, blow molding method, foam molding method and gas-injection molding method since fluidity during melting is excellent. This molded article includes a part such as a housing and a container (for example, a fuel tank) that are used in wide field exemplifying daily goods, parts for vehicles, electric/electronic parts, mechanical parts and the like; a meter case for vehicles and for measuring apparatuses; a hose connector, a cut-off valve, a fuel pump casing, an inlet pipe and the like. As the parts for vehicles, lamp-housing is preferable and a lamp-housing for vehicles (including two-wheelers, four-wheelers and the like) such as housings for head lamp, extensions and housings for high mount stop lamp; a lamp-housing for appliance, a lamp-housing for measuring apparatuses and the like may be used.

1. A molding material for welding, comprising an acrylic rubber-reinforced vinyl-based resin [A1] obtained by polymerizing a vinyl based monomer [b1] containing an aromatic vinyl compound and a cyanidated vinyl compound in the presence of an acryl-based rubbery polymer [a1] whose toluene gel content is less than 70%, or a mixture consisting of said acrylic rubber-reinforced vinyl-based resin [A1] and a (co)polymer [A2] of a vinyl based monomer [b2], wherein content of said acryl-based rubbery polymer [a1] is in the range from 5 to 40% by mass with respect to the total amount of said molding material for welding.

2. The molding material for welding according to claim 1, wherein said acryl-based rubbery polymer [a1] is a copolymer of an acrylic acid alkyl ester (m1) having an alkyl group whose carbon number is in the range from 1 to 12, a compound (m2) which is copolymerizable with said acrylic acid alkyl ester (m1) and a multifunctional vinyl compound (m3), and has a mean volume particle diameter in the range from 40 to l90 nm, and has a degree of swelling in toluene is in the range from 6 to 20, wherein the ratio of said acrylic acid alkyl ester (m1) and said compound (m2) to be used based on 100% by mass of the total amount of these compounds are 60 to 100% by mass and 0 to 40% by mass, respectively, and wherein the amount of said multifunctional compound (m3) to be used based on 100 parts by mass of the total amount of said acrylic acid alkyl ester (m1) and said compound (m2) is in the range from 0.1 to 10 parts by mass.

3. The molding material for welding according to claim 1, wherein said acryl-based rubbery polymer [a1] is a polymer that is obtained by comprising first step for copolymerizing an acrylic acid alkyl ester (m11) having an alkyl group whose carbon number is in the range from 1 to 12, a compound (m21) which is copolymerizable with said acrylic acid alkyl ester (m11) and a multifunctional vinyl compound (m31) at a polymerization conversion rate of 85% or higher, and second step for copolymerizing an acrylic acid alkyl ester (m12) having an alkyl group whose carbon number is in the range from 1 to 12, a compound (m22) which is copolymerizable with said acrylic acid alkyl ester (m12) and a multifunctional vinyl compound (m32) in the presence of the copolymer obtained by said first step at a polymerization conversion rate of 85% or higher,
wherein the total amount of said acrylic acid alkyl ester (m11) and said compound (m21) to be used in said first step based on 100% by mass of the total of said acrylic acid alkyl esters (m11) and (m12) and said compounds (m21) and (m22) is in the range from 50 to 90% by mass, and the amount of said multifunctional vinyl compound (m31) to be used is in the range from 0.01 to 0.3 part by mass based on 100 parts by mass of said acrylic acid alkyl esters (m11) and said compounds (m21), and
wherein the total amount of said acrylic acid alkyl ester (m12) and said compound (m22) to be used in said first step based on 100% by mass of the total of said acrylic acid alkyl esters (m11) and (m12) and said compounds (m21) and (m22) is in the range from 10 to 50% by mass, and the amount of said multifunctional vinyl compound (m32) to be used is in the range from 0.5 to 10 parts by mass based on 100 parts by mass of said acrylic acid alkyl esters (m12) and said compounds (m22).

4. The molding material for welding according to claim 1, wherein the toluene gel content of said acryl-based rubbery polymer [a1] is in the range from 45% to 69%.

5. The molding material for welding according to claim 1, wherein the content of said acryl-based rubbery polymer [a1] is in the range from 10 to 30% by mass based on the total of said molding material for welding.

6. The molding material for welding according to claim 1, wherein the number of stringing observed at the time a test piece which is made of said molding material for welding and has a length of 100 mm, a width of 30 mm and a thickness of 3 mm is released from a heated plate after said test piece is subjected to conditioning at a temperature of 23° C. and at a relative humidity of 50% for 3 hours, and to contacting with said heated plate under a test condition below is 3 pieces or less.
<Test Conditions>
Temperature of the heated plate; 280° C.
Transfer speed; 200 mm/sec.
Time for contacting the test piece with the heated plate; 15 sec.
Melted length of the test piece; 0.5 mm

7. The molding material for welding according to claim 1, wherein the deflection temperature (under load) measured in accordance with ISO75 is 80° C. or higher.

8. The molding material for welding according to claim 1, wherein it is for molding a lamp-housing.
